(19) United States
(12) Patent Application Publication
(10) Pub. No.: US 2009/0047891 A1
(43) Pub. Date: Feb. 19, 2009

(54) VENTILATION DEVICE AND METHOD FOR MANUFACTURING A VENTILATION DEVICE

(76) Inventors: Wolfgang Dieksander, Filderstadt (DE); Harald Horig, Bischweier (DE)

Correspondence Address: GREER, BURNS & CRAIN, 300 S WACKER DR, 25TH FLOOR, CHICAGO, IL, 60606, US

(21) Appl. No.: 11/660,241

(22) PCT Filed: Aug. 10, 2005
(86) PCT No.: PCT/EP2005/008693

§ 371 Date: Sep. 4, 2008

(30) Foreign Application Priority Data
Aug. 13, 2004 (DE) 10 2004 039 442.3

(51) Int. Cl. B60H 1/00

(52) U.S. Cl. 454/152; 296/187.03; 29/592

(57) ABSTRACT

A ventilation device, in particular for motor vehicles; wherein the ventilation device has, at a determinable point of the ventilation device, an area that, when subjected to a specified load, changes its shape in a manner predetermined by a structure of the ventilation device in the area; and a deformation energy caused by the load being absorbed during the change of shape.

The present invention relates to a ventilation device, in particular for motor vehicles, and to a method for manufacturing such a ventilation device.

Ventilation devices for conditioning, in particular heating and cooling, air that is conducted into a passenger compartment of a motor vehicle, and/or for ventilating passenger compartments, are known from the prior art.

These ventilation devices standardly have a housing through which there flows an air stream that enters the housing through an air inlet and an air stream that exits the housing through an air outlet. In the housing, there are situated flow elements that form flow ducts, such as valves, ducts or plates, and means for conditioning and mixing air streams.

At the air inlets and outlets, there are situated ventilation ducts or duct outlets through which the entering and exiting air streams flow. To the ventilation ducts there are connected mainly additional flow elements, such as nozzles or connecting ducts, coupled via connecting flanges or collars, via which the flow paths can be guided to a desired ventilation location.

However, these ventilation devices have the disadvantage that they are constructed from rigid elements, in particular rigid housing parts and duct outlets, which do not have any functional and/or structural precautions for a certain energy absorption when loaded.

If, for example in the case of a crash of a motor vehicle, these rigid elements receive impacts from other elements, in particular deformationally rigid ones such as cockpit parts, e.g. a radio, a windscreen, a heater operating panel, or air exit nozzles, there results an uncontrolled absorption of energy over a short (in particular given compact designs as in the automotive sector) deformation path of the rigid elements involved. The short deformation path is a result in particular of the rigidity of the elements.

The risk of injury for occupants of such a motor vehicle, for example in the case of an impact to the head, is increased.

The object of the present invention is to provide a ventilation device, in particular for motor vehicles, that reduces the problems known from the prior art and that can be manufactured economically.

This object is achieved by a ventilation device, as well as a manufacturing method for a ventilation device, having the features of the respective independent claim.

Advantageous specific embodiments and developments are the subject matter of the subclaims. The subject matter of the subclaims relates both to the ventilation device according to the present invention and to the manufacturing method according to the present invention.

The ventilation device according to the present invention, in particular for motor vehicles, has, at a determinable point of the ventilation device, an area that, when subjected to a specified load, changes its shape in a manner predetermined by a structure of the ventilation device in said area.

During this change of shape, a deformation energy caused by the loading is absorbed.

In the manufacturing method according to the present invention for the ventilation device, a determinable point of the ventilation device is processed in such a way that an area is formed that changes its shape under a prespecified load in a manner predetermined by a structure of the ventilation device in said area.

Here, “in a manner predetermined by a structure” is understood to mean that the structure of the ventilation device in said area is adapted in a targeted fashion in such a way that when loaded a change in shape is effected there that is deliberately caused, i.e. defined, and that is not uncontrolled.

In this way, through the present invention it is advantageously achieved that the deformation energy is defined in a structurally conditioned manner, and in particular is absorbed via a larger deformation path, caused by the change of shape when the ventilation device is loaded.

Thus, put clearly, the deformation energy is absorbed in a defined manner, so that the ventilation device, or its volume, is made use of, in particular as a lengthened deformation path.

The present invention also advantageously brings it about that through the defined energy absorbing over the larger deformation path, a risk of injury to passengers of a motor vehicle in the case of a crash can be reduced.

The ventilation device, for example a ventilation system, a heating system, or an air-conditioning system in a motor vehicle, has, according to a particularly preferred specific embodiment, at least one housing having a housing wall and having a ventilation duct that is situated at a flow opening of the housing.

In addition, the ventilation device can preferably have a connecting element, in particular a connecting duct collar or a nozzle, that is connected in particular to the ventilation duct.

As the determinable point, in particular the above-named elements of the ventilation device are suitable. Thus, as the determinable point preferably the housing, here in particular a housing wall, and specifically an outer wall of the housing, or the connecting element, or a connecting area between the housing and the connecting element, can be provided.

The determinable point can also be the ventilation duct, in particular a duct collar having a support flange or collar, or a connecting area between the ventilation duct and the connecting element.

The area provided for the change of shape can have an arbitrary structure. Preferably, the area is realized as a point or line or otherwise dimensioned two- or three-dimensional surface or body, in particular as an approximately cylindrical body.

According to a particularly preferred specific embodiment, the structure is a weakened area of the housing, forming an intended break point. This weakened area can have the shape of a point or of a line, or a variously dimensioned surface.

Particularly preferably, the structure is a groove forming an intended break point, in particular in the housing wall or in the ventilation duct or the connecting element. This groove can be line-shaped or can be an open or closed polygonal curve, for example being C-shaped or T-shaped or X-shaped, or some combination thereof. In particular in the case of tubes, cylindrical bodies, or similar three-dimensional bodies, it can also be circumferential.

Preferably, the structure, in particular in the above-named device parts, can also be a wall thinning, a housing interruption, or a housing opening, or combinations thereof.

Housing interruptions can for example be interrupted rib structures having variously shaped or variously running ribs, or having in general protruding, thin-walled raised parts, which then can also be used as bearers for seals for the connection of connecting parts.

These interrupted rib structures can for example be fashioned having X-shaped, T-shaped, or C-shaped ribs, or combinations thereof. Here, “interrupted” can mean that individual ribs are not connected to one another, i.e., they have interruptions, or ribs can have interruptions to edges. Such interrupted rib structures then have a structure-weakening effect. This can be further supplemented by grooves situated between the ribs.

The housing openings can in particular be fashioned as C-shaped, T-shaped, or X-shaped openings or slots, or combinations thereof. Polygon-shaped or line-shaped or arbitrarily shaped surface-type slots and openings are also possible. Here as well, supplemental grooves or ribs can be fashioned between the slots.

In another, particularly preferred specific embodiment, the structure is a coupling that enables a relative movement, in particular a longitudinal displacement, in particular between the ventilation duct and the connecting element.

This coupling can be effected using a ring placed into a groove that runs circumferentially on an inner wall of the connecting element and/or on an outer wall of the ventilation duct.

The relative movement enabled by the coupling can effect a length compensation, preferably in such a way that the ventilation duct and the connecting element move against each other in telescoping fashion in the longitudinal direction.

Of course, in the ventilation devices it can be provided to combine arbitrary combinations of the above-named structures with one another. For example, ribs, specifically C-shaped, T-shaped, or X-shaped ribs, can be combined with slots, specifically C-shaped, T-shaped, or X-shaped slots. Also, grooves, specifically circumferential grooves, can be combined with the ribs, in particular C-shaped, T-shaped, or X-shaped ribs. Also, slots, in particular C-shaped, T-shaped, or X-shaped slots, can be combined with grooves, in particular with groove-type connections between slots.

Such combined structures can bear seals.

In addition, the couplings that enable the longitudinal displacement can then also be combined.

Particularly preferably, the predetermined manner in which the change of shape takes place is as a break, a deformation, a shearing off, a displacement, and/or a relative movement between elements of the ventilation device.

Preferably, the structure is adapted to the predetermined load; i.e., here it can be provided that a change of shape of the structure is brought about only given particular directions of loading, or directional components, and/or given particular load magnitudes, or the exceeding of such magnitudes.

This adaptation can for example be realized by corresponding dimensions, such as groove depth, rib thickness, rib height, intended break point shape or slot width, and the like.

In this way, undesired and uncontrolled changes in shape can be avoided.

The predetermined load can be caused by elements impacting the ventilation device, in particular cockpit parts. Such impacting of elements can be initiated or caused by a crash.

The present invention and further advantages are explained below in a plurality of exemplary embodiments, which are not intended as a limitation of the present invention.

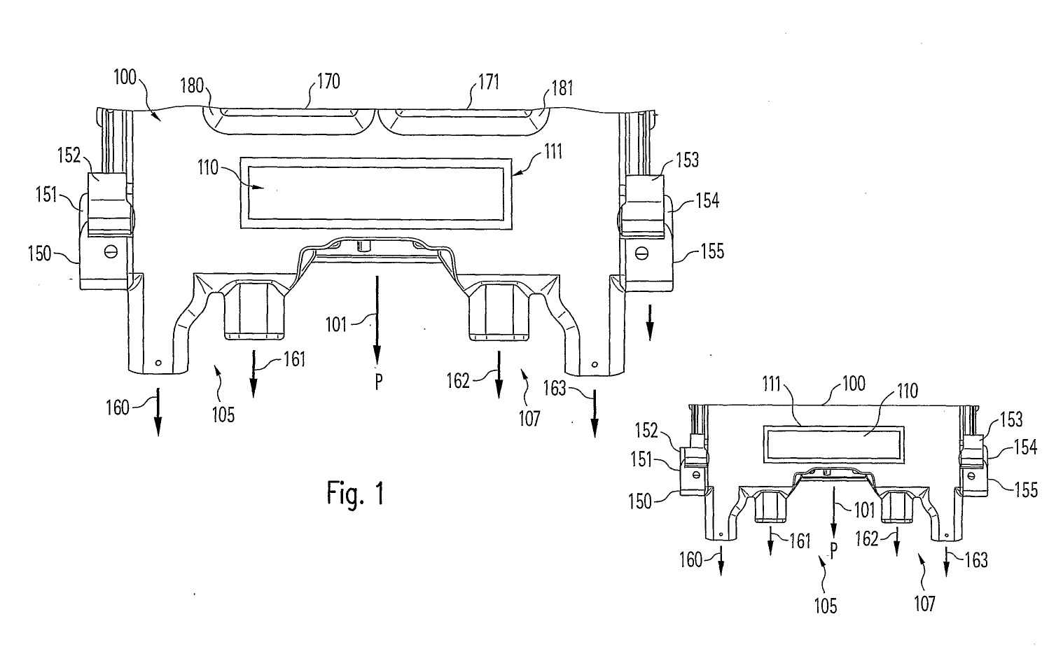

FIG. 1 shows a schematic representation of a housing of a motor vehicle air conditioning system having a weakened area on the housing, forming an intended break point, according to an exemplary embodiment;

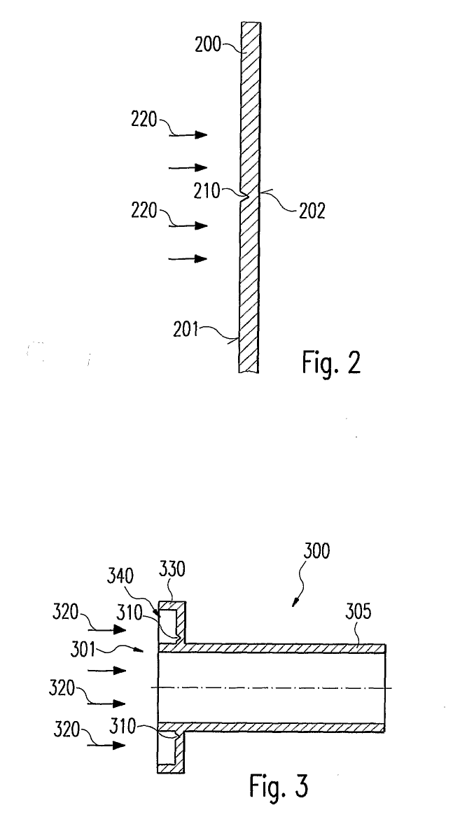

FIG. 2 shows a schematic representation of a housing wall having a weakened area forming an intended break point according to an exemplary embodiment;

FIG. 3 shows a sectional representation of a duct collar having a support flange that has an intended break point according to an exemplary embodiment;

FIG. 4 shows a schematic representation of a support flange of a duct collar having defined interruptions in order to form intended break points, according to an exemplary embodiment;

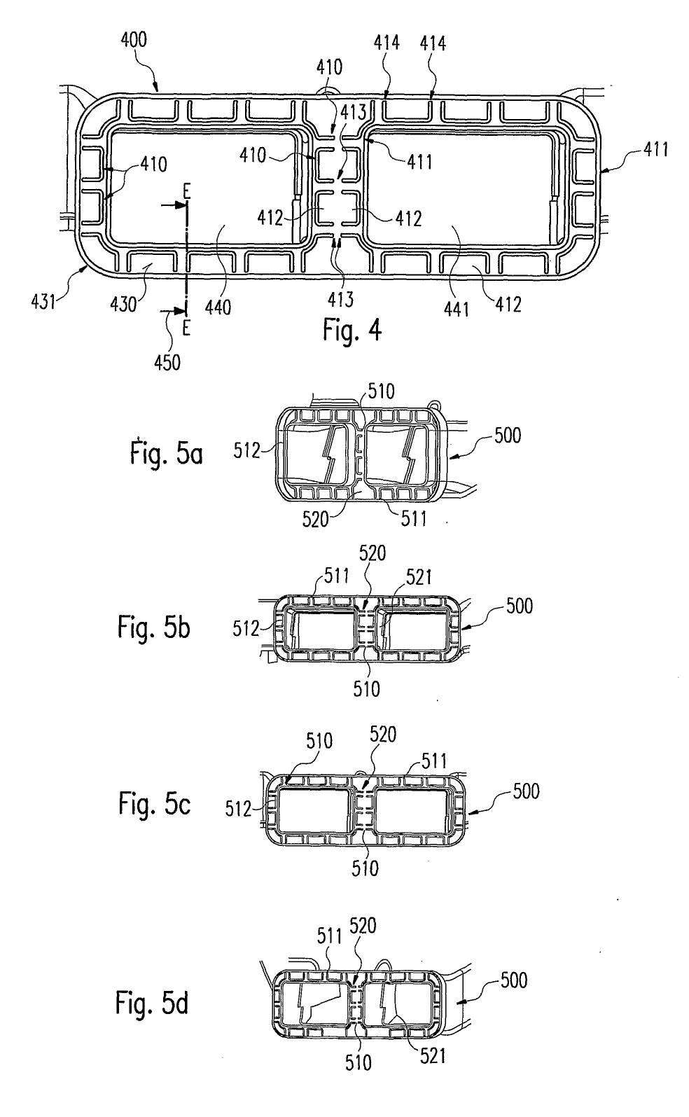

FIGS. 5a to d show schematic representations of a support flange of a duct collar having an intended break point according to an exemplary embodiment;

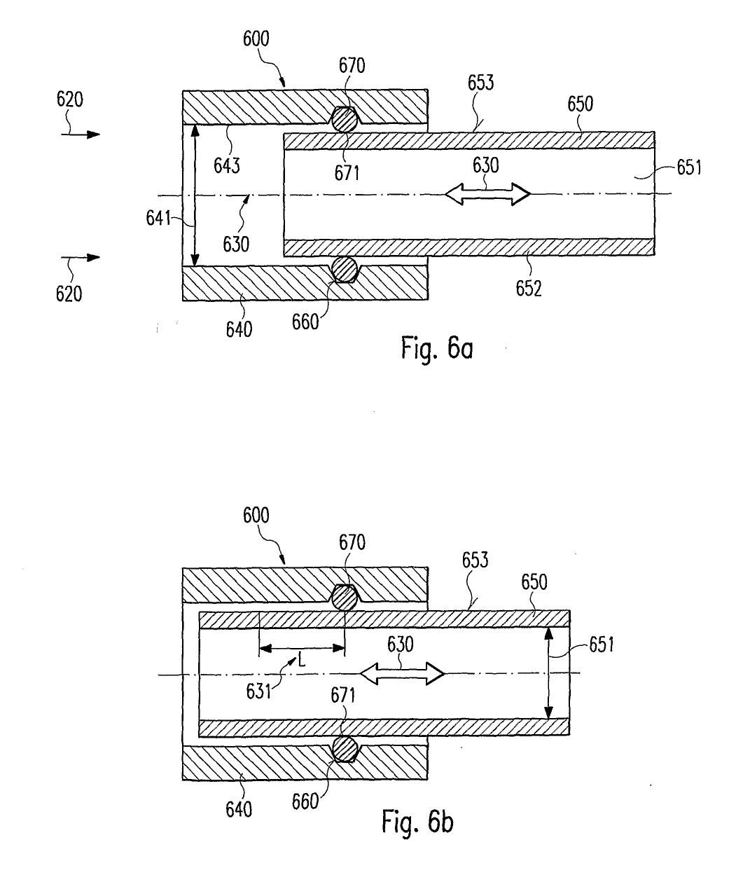

FIG. 6 shows a schematic representation of tubes that can be pushed into one another, by which a (lengthened) deformation path is formed through length compensation, according to an exemplary embodiment;

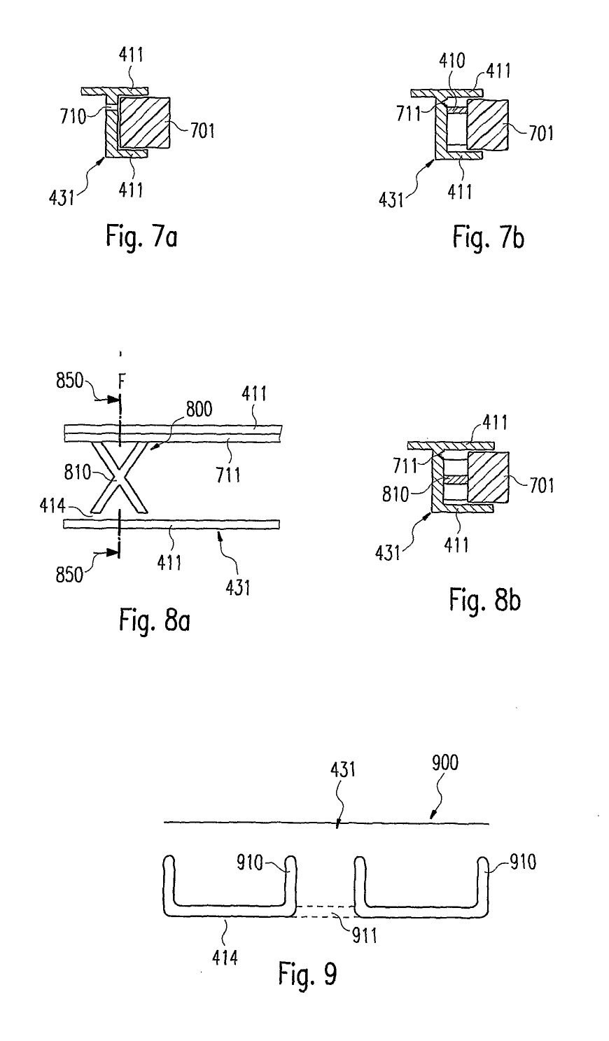

FIGS. 7a to b show schematic representations of structures forming intended break points on a support surface of a connecting flange, as can be fashioned according to FIG. 4, according to exemplary embodiments;

FIGS. 8a to b show schematic representations of a structure forming intended break points on a support surface of a connecting flange, as can be fashioned according to FIG. 4, according to an exemplary embodiment;

FIG. 9 shows a schematic representation of a structure forming intended break points on a support surface of a connecting flange as can be fashioned according to FIG. 4, according to an exemplary embodiment.

### FIRST EXEMPLARY EMBODIMENT

### Defined Weakened Area on the Housing of a Motor Vehicle Air Conditioning System

FIG. 1 shows housing 100 of a motor vehicle air conditioning system, oriented in arrow direction P 101 in a vehicle tunnel 105. On both sides of housing 100, there are situated air outlet ducts 150 to 155 for ventilating a foot area of a passenger compartment of a motor vehicle, as well as lateral areas of the passenger compartment.

On the underside 107 of housing 100, additional outlet ducts 160 to 163 are situated for additional ventilation of the passenger compartment.

In addition, housing 100 of the motor vehicle air conditioning system has additional air outlet openings 170, 171 (only partially visible) on which there are situated duct collars having connecting flanges 180, 181.

FIG. 1 shows an area 110 of housing 100 that, in the manner of a frame, is surrounded by a circumferential 90° groove 111 that forms a rectangular polygon. This 90° curve 111, formed in this case on an outer surface of the housing wall, forms a defined weakened area on housing 100 of the motor vehicle air conditioning system; i.e., an intended break point.

In the case of an accident (crash) of the motor vehicle, this area 110, i.e. the intended break point becomes, when cockpit parts, such as radio, windscreen, heating/air conditioning operating panel, etc., impact housing 100 a predetermined breaking point; i.e., housing 100 breaks in a defined, intentional manner at this point.

This is because the defined weakened area 110 on housing 100 has the effect that there only a small kinetic energy—that is, a small kinetic energy in comparison with normal, unweakened housing areas—need be applied in order to break through or penetrate the housing wall.

Housing 100 of the vehicle air conditioning system is weakened in a defined manner at this point, and can thus break in a defined manner there; i.e., in general can deform there in a defined manner.

In this way, the risk of injury to occupants of a motor vehicle involved in an accident is reduced.

It is to be noted that arbitrary other shapes of weakened areas, for example round, oval, square, or star-shaped areas, can be formed by a corresponding groove shape.

Groove 111 can be fashioned on the outer surface, as is shown in FIG. 1, and/or on the inner surface of a housing wall.

### SECOND EXEMPLARY EMBODIMENT

### Defined Weakening of a Housing Wall by a Groove

FIG. 2 shows a section of a housing wall 200 that can occur for example in an air conditioning system housing for a motor vehicle.

On a surface 201 of housing wall 200 (here the outward-facing surface 201 of an outer wall is shown), a groove 210, forming an intended break point, is fashioned as a defined weakened area on housing wall 200.

Arrows 220 illustrate a direction of acceleration of vehicle parts, such as cockpit parts, impacting in the area of housing wall 200 that is weakened by groove 210.

If, for example during a crash of a motor vehicle, these parts impact housing wall 200 in arrow direction 220 in the area of the intended break point, or have movement components in arrow direction 220, housing wall 200 breaks in a defined manner at the point weakened by groove 210.

The shape and depth of the groove are selected so that breakage does not occur until a particular force (with respect to magnitude and direction) is exerted. In this way, undesired breaks at the intended break point can be avoided.

It is to be noted that the groove that forms intended break point 210 can, instead of being situated on the outward-facing wall surface, also be situated on inward-facing wall surface 202 of housing wall 200.

### THIRD EXEMPLARY EMBODIMENT

### Support Flange of a Duct Collar Having a Defined Grooved Wall Weakened Area, Forming an Intended Break Point

FIG. 3 shows, in longitudinal section, a duct collar 300 that is an essentially tube-shaped component having a tube segment 305. On one end 301 of duct collar, or of tube segment 305, there is fashioned a support flange, also called a collar, 330 (cf. FIGS. 4, 5 a to d). In a transition area of flange 330, a circumferential groove 310 is made on tube segment 305.

This groove 310 forms an intended break point.

When a predeterminable force acts, which can be influenced with respect to magnitude and direction by targeted fashioning of the shape and depth of groove 310, flange 330 shears at the intended break point formed by groove 310 in a defined manner.

Here, FIG. 3 indicates, via arrows 320, a direction of acceleration of vehicle parts, such as cockpit parts, impacting at a normal orientation to flange 330.

If these parts impact in arrow direction 320 on the flange, or have movement components in arrow direction 320, the flange breaks through, or off, or shears through, or off, in a defined manner at the point weakened by groove 310.

It is to be noted that a corresponding effect can also be achieved by defined housing interruptions 340, such as interrupted ribs or webs (FIG. 4).

### FOURTH EXEMPLARY EMBODIMENT

### Support Flange of a Duct Collar Weakened in a Defined Manner (FIG. 4)

FIG. 4 shows a support flange 400 of a duct collar in a top view of a support surface 430 of support flange 400.

The duct collar or support flange has, as is shown, two air guidance openings 440, 441 around which there runs a collar 431 of flange 400, said collar 431 forming support surface 430.

Via support surface 430, a seal placed thereon and fitted thereto (cf. FIG. 7b, 701) a fluid-tight connection to a connecting duct collar or a nozzle (not shown) can be created.

Such a seal 701 can for example also be glued to support surface 430.

In addition, FIG. 4 shows schematically indicated ribs 410 that are distributed on collar 431 or on support surface 430, as well as an edge 411 that limits support surface 430 inwardly and outwardly; both of these, i.e. ribs 410 and edge 411, each have a predetermined height, according to which the thickness of the seal is then dimensioned. In the present case, the circumferential edges 411 have a larger height than do ribs 410, in order to counteract a displacement of the seal 701.

As is shown, ribs 410 and edge 411 protrude from the plane of the drawing, and their heights, which in this case are different, are not visible.

In addition, FIG. 4 shows that ribs 410 have an essentially C-shaped structure, forming a frame 412 that is open towards one side. Ribs 410 are also not connected among one another 413, and are also not connected 414 to edge 411 or edges 411, so that defined interruptions 413, 414 of the ribs/edge structure are formed on support surface 430 or on collar 431.

Through these defined interruptions 413, 414, which can be formed according to load magnitude and direction, collar 431 is weakened at the interruption points, and can there form defined intended break points or deformation points, for example in the case of a loading of collar 431 in the case of an accident or crash of a vehicle (see FIGS. 5a to d).

Arrows 450 and a letter E designate a section through collar 431 that comprises the ribs/edge structure. FIG. 7b shows an associated sectional representation, in which the represented parts, where identical, are designated as in FIG. 4.

In addition, FIG. 7b shows seal 701, which is situated on ribs 410 and is limited by the edges 411 of collar 431.

As an additional structural element forming an intended break point, collar 431 can be equipped or weakened with a groove 711, as is shown in FIG. 7b.

As is shown in FIG. 7b, groove 711 runs along edge 411 in the intermediate space between rib 400 and edge 411.

Additional structures of this sort, forming alternative specific embodiments of intended break points, are shown in FIGS. 7 to 9, and are described below with reference to these Figures.

### FIFTH EXEMPLARY EMBODIMENT

### Support Flange, Weakened in a Defined Manner, of a Duct Collar

FIGS. 5a to d illustrate a breakage behavior, in particular a shearing off, of a duct collar 500 having intended break points 510 to 512, or of a support flange of duct collar 500, which can for example be realized in the manner of the exemplary embodiments described above.

As intended break points 510 to 512, in duct collar 500 a groove 512 is provided at a connecting point of collar 520 to tube segment 521 (cf. FIG. 3), and structural interruptions 510, 511 are provided in the ribs/wall structure of collar 520 (cf. FIG. 4).

Through these intended break points 510 to 512, the support flange is intentionally constructively weakened in such a way that collar 520 can shear off at the connecting points, as is shown in FIGS. 5a to d. Here, the intended break points are dimensioned in such a way that the shearing off is not effected until a load exceeds a particular magnitude in a defined direction.

### SIXTH EXEMPLARY EMBODIMENT

### Deformation Path Through Length Compensation Between Two Tubes of a Tube Connection (FIGS. 6a and b, 600)

FIGS. 6a and 6b show a (fluid-tight) tube connection 600 having two tubes 640, 650, tube 640 forming a duct or a nozzle and tube 650 forming an air outlet on a vehicle air conditioning system.

Tube diameters 641 and 651 of the two tubes 640, 650, a sealing ring 670 situated between the two tubes 640, 650, and at least the wall thicknesses 652 of tube 650 are coordinated to one another in such a way that the tube connection is, as is described below, on the one hand fluid-tight, but on the other hand the two tubes 640, 650 can be displaced in a longitudinal directions 630 relative to one another under a defined load. As is shown in FIGS. 6a and 6b, here tube 640 can be pushed into tube 650, or displaced therein.

On the inner wall 643 of tube 640, there is a radially circumferential groove 660, in which the correspondingly fitted sealing ring 670 is placed.

As is shown in FIGS. 6a and 6b, sealing ring 670 is situated with its inner diameter 671 on the surface 653 of tube 650, so that, given a corresponding selection of the dimensions and diameters, a fluid-tight connection is created between the two tubes 640, 650.

FIG. 6a shows tube connection 600 of the two tubes 640, 650 before a force (for example due to a crash of the motor vehicle having this tube connection 600) acts on tube 640; i.e., in a normal state.

In FIG. 6a, arrows 620 identify a direction of acceleration of vehicle or cockpit parts impacting on tube connection 600, such as would occur during such an accident or if such a force were applied.

The represented direction of acceleration 620 runs in the longitudinal direction 630 of tubes 640, 650, or parallel thereto. In the case of forces and directions of acceleration oriented differently, here the corresponding components in the longitudinal direction 631 are to be understood.

As is shown in FIG. 6b, under the action of the force the two tubes 640, 650 move towards one another in longitudinal direction 630. FIG. 6b shows the case in which tube 650 moves towards tube 640, due to the fact that receiving groove 660 of sealing ring 670 is made in tube 640.

In FIG. 6b, L identifies, as an example, a particular movement path 631 (length compensation) by which tube 650 is pushed further into tube 640 under the action of a particular force.

Through the relative displacement of tubes 640, 650 to one another by movement path L 631 (length compensation), the deformation path is lengthened via which the kinetic energy of impacting cockpit parts is absorbed.

In this way, the kinetic energy is defined, and is absorbed in a less jerky fashion, reducing the risk of injury to vehicle occupants.

The components forming tube connection 600 are dimensioned as already described, in such a way that tube connection 600 on the one hand is fluid-tight, and on the other hand this length compensation 631 between the two tubes 640, 650 can be brought about. In addition, they are dimensioned in such a way that length compensation 631 is not brought about until the load on tube connection 600 exceeds particular limits in its direction and magnitude. In this way, an undesired and uncontrolled length compensation 631, for example due to impacts and forces occurring during normal vehicle operation, is avoided.

### SEVENTH TO TENTH EXEMPLARY EMBODIMENT

### Structures Forming Alternative Intended Break Points on a Support Surface of a Connecting Flange (FIGS. 7 to 9)

The following structures, forming alternative intended break points, refer to the flange 400 or collar 431 shown in FIG. 4 and described as a fourth exemplary embodiment. Identical parts are designated identically.

Alternatively to the ribs/edge structure on support surface 430 of collar 431 according to the fourth exemplary embodiment, a slot/edge structure, as is shown in FIG. 7a in a corresponding section E (cf. section E, 450 in FIG. 4 and FIG. 7b), can also be formed.

In this case, instead of C-shaped ribs 410, correspondingly shaped C-shaped slots 710 are made in collar 431. In this case, seal 701 lies immediately on support surface 430.

FIGS. 8a and b show another alternative ribs/edge structure 800, forming an intended break point, with (circumferential) groove 711.

FIG. 8a shows a segment of collar 431 in a top view. FIG. 8b is a sectional representation F of the collar along the sectional curve identified with reference character 850.

In this ribs/edge structure 800, ribs 810 are fashioned with an X shape. These ribs also have weakening spaces 414 to the edges 411 of collar 431. Along an edge 411 and in the intermediate space between rib 810 and edge 411, a likewise weakening circumferential groove 711 is made.

As is shown in FIG. 8b, in this case seal 701 is situated on ribs 810, whose height is fashioned lower than the edges 411, and seal 701 is limited against displacement by edges 411.

FIG. 9 schematically shows another alternative slot/edge structure 900 of flange 400 or of collar 431.

Here, as FIG. 9 shows, C-shaped slots 910 are situated as shown on a segment of collar 431. Between each pair of slots 910, a groove 911 is made in support surface 430 that connects slots 910 in the manner shown. Here as well, slots 910 have weakening edge spacings 414.

1. A ventilation device, in particular for motor vehicles: comprising
the ventilation device having, at a determinable point of the ventilation device, an area that, when subjected to a specified load, changes its shape in a manner predetermined by a structure of the ventilation device in said area; and
a deformation energy caused by the load being absorbed during the change of shape.

2. The ventilation device as recited in claim 1, wherein
the ventilation device has at least one housing having a housing wall and having a ventilation duct that is situated at a flow opening of the housing.

3. The ventilation device as recited in claim 1, wherein
the ventilation device has a connecting element, in particular a connecting duct collar or a nozzle, that is connected in particular to the ventilation duct.

4. The ventilation device as recited in claim 1, wherein
the determinable point is the housing or the connecting element or a connecting area between a housing and a connecting element.

5. The ventilation device as recited in claim 1, wherein
the determinable point is a housing wall, in particular an outer wall of the housing, or the ventilation duct, in particular a duct collar having a support flange or collar, or a connecting area between a ventilation duct and a connecting element.

6. The ventilation device as recited in claim 1, wherein
the area is a point or a line or a surface or a body, in particular an approximately cylindrical body.

7. The ventilation device as recited in claim 1, wherein
the structure is a weakened area on a housing, forming an intended break point.

8. The ventilation device as recited in claim 1, wherein
the weakened area is fashioned in the shape of a point or in the shape of a line or as a surface.

9. The ventilation device as recited in claim 1, wherein
the structure is a groove forming an intended break point, fashioned in particular as a line-shaped and/or circumferential groove or as an open or closed polygonal line, made in particular in a housing wall or in a ventilation duct or in a connecting element.

10. The ventilation device as recited in claim 1, wherein
the structure is a wall thinning, forming an intended break point, in particular in a housing wall or in a ventilation duct or in a connecting element.

11. The ventilation device as recited in claim 1, wherein
the structure is a housing interruption forming an intended break point, in particular a rib structure comprising interruptions, having ribs, in particular C-shaped or X-shaped or T-shaped ribs, and/or having a housing opening, in particular fashioned as a C-shaped or T-shaped or X-shaped opening, in particular in a housing wall or in a ventilation duct or in a connecting element.

12. The ventilation device as recited in claim 1, wherein
the structure is a coupling that enables a relative movement, in particular a longitudinal displacement, in particular between a ventilation duct and a connecting element.

13. The ventilation device as recited in claim 1, wherein
the coupling between the ventilation duct and the connecting element is effected using a ring placed into a groove that runs circumferentially on an inner wall of a connecting element or on an outer wall of a ventilation duct.

14. The ventilation device as recited in claim 1, wherein
during the relative movement, a length compensation takes place in such a way that a ventilation duct is pushed against a connecting element in the longitudinal direction in a telescoping manner.

15. The ventilation device as recited in claim 1, wherein
the predetermined manner in which the change of shape takes place is a breaking, a deformation, a shearing off, a displacement, and/or a relative movement.

16. The ventilation device as recited in claim 1, wherein
the structure of the ventilation device in the area is fashioned such that the deformation energy is absorbed in a defined manner, in particular via a longer deformation path.

17. The ventilation device as recited in claim 1, wherein
the specified load is able to be specified with respect to its magnitude and/or direction.

18. The ventilation device as recited in claim 1, wherein
the specified load is caused by elements, in particular cockpit parts, impacting on the ventilation device.

19. The ventilation device as recited in claim 1, wherein
the impacting of the elements is caused by a crash.

20. The ventilation device as recited in claim 1, wherein
the ventilation device is a ventilation system, a heating system, or a air conditioning system in a motor vehicle.

21. A method for manufacturing a ventilation device, in particular for motor vehicles: comprising
processing the ventilation device at a determinable point of the ventilation device in such a way that at the determinable point an area is formed that, when subjected to a specified load, changes its shape in a manner predetermined by a structure of the ventilation device in said area; and
causing a deformation energy by the load being absorbed during the change of shape.
